(19) United States
(12) Patent Application Publication
(10) Pub. No.: US 2025/0062539 A1
(43) Pub. Date: Feb. 20, 2025

(54) WAVEGUIDE TO ANTENNA SLOT CONFIGURATIONS

(71) Applicant: Magna Electronics, LLC, Southfield, MI (US)

(72) Inventors: Konstantinos Konstantinidis, Wurzburg (DE); Angelos Alexanian, Lexington, MA (US); Scott B. Doyle, Sudbury, MA (US)

(21) Appl. No.: 18/234,362

(22) Filed: Aug. 15, 2023

(51) Int. Cl. H01Q 13/02; H01Q 1/27

(52) U.S. Cl. CPC H01Q 13/0233; H01Q 1/27

(57) ABSTRACT

Waveguide and/or antenna structures for use in RADAR sensor assemblies and the like comprising unique antenna slot transitional features. In some embodiments, an antenna module for a vehicle sensor may comprise a waveguide having a waveguide ridge extending therein. The waveguide ridge may comprise an elongated axis along which the waveguide ridge extends. An antenna slot may be operably coupled with the waveguide and may comprise an elongated axis along which the antenna slot extends. The elongated axis of the antenna slot may be at least substantially aligned with or at least substantially parallel to the elongated axis of the waveguide ridge.

### SUMMARY

Disclosed herein are various embodiments of waveguide and/or antenna structures having features for improving performance, improving compactness, and/or decreasing costs of a sensor assembly and/or module incorporating these features/structures. In preferred embodiments, such features/structures may be used in RADAR or other sensor modules for vehicles.

In some embodiments, a transitional region between one or more waveguides and/or waveguide ridges and their corresponding antenna slot(s) may be configured to align and/or make an elongated axis of an antenna slot(s) of the structure parallel to its corresponding waveguide and/or waveguide ridge(s). In some embodiments, a gap or gap region may be defined adjacent to the antenna slot. In some such embodiments, this gap region may be configured as a quarter-wavelength stub, which may allow for confining electromagnetic fields being transmitted and/or received via the antenna slots and/or allow for obtaining impedance matching with respect to an associated waveguide and/or waveguide ridge.

In a more particular example of an antenna module for a vehicle sensor according to some embodiments, the module may comprise one or more waveguides. In some embodiments, a waveguide ridge may extend within one or more of the waveguides. In some embodiments comprising waveguide ridges, each waveguide ridge may comprise an elongated axis along which the waveguide ridge extends. The module may further comprise an antenna slot operably coupled with each waveguide, the antenna slot comprising an elongated axis along which the antenna slot extends. The elongated axis of one or more of the antenna slots may be at least substantially aligned with, or at least substantially parallel to, the elongated axis of its associated waveguide ridge.

In some embodiments, one or more of the waveguides may extend along a side of its corresponding antenna slot. In some such embodiments, the waveguide(s) may extend along both opposing sides of its corresponding antenna slot, the sides defining the elongated axis of the antenna slot. In some embodiments, the antenna slot(s) may be non-centered with respect to opposing sides of its respective waveguide(s) in the region of the waveguide(s) adjacent to the opposing sides of the antenna slot(s).

Some embodiments may comprise a gap between a first side of the antenna slot(s) and a first side of the waveguide(s) adjacent to the first side of the antenna slot(s). In some such embodiments, the gap may comprise a distance and/or average distance of between about 0.6 mm and about 1.3 mm and/or may define a distance and/or average distance of about one-fourth of a wavelength of RADAR for which the vehicle sensor is configured to operate.

In some embodiments, the waveguide(s) may be defined in between two or more rows of opposing posts. Alternatively, the waveguide(s) may be defined in between continuous waveguide sidewalls.

In another example of an antenna module according to various embodiments, the module may comprise a plurality of waveguides and, in some cases, a corresponding plurality of waveguide ridges. In embodiments comprising waveguide ridges, each waveguide ridge of the plurality of waveguide ridges may be positioned and may extend within a corresponding waveguide of the plurality of waveguides. The module may further comprise a plurality of antenna slots, each antenna slot of the plurality of antenna slots being positioned within a terminal end of a corresponding waveguide of the plurality of waveguides.

In some embodiments, each antenna slot of at least a subset of the plurality of antenna slots may be positioned in a non-centered configuration within the terminal end of its corresponding waveguide. In some such embodiments, the non-centered configuration may be defined, at least in part, by a gap. In some such embodiments, the gap may be defined between a first side of each antenna slot of the at least a subset of the plurality of antenna slots and an adjacent side of its corresponding waveguide.

In some embodiments, the gap may comprise a distance that is greater than a gap, if any, that may be present on an opposite side of the antenna slot. In some embodiments, the gap may comprise a distance, such as an average distance, of between about 0.6 and about 1.3 mm. In some such embodiments, the gap may comprise a distance and/or average distance of between about 0.8 and about 1.1 mm.

In some embodiments, each antenna slot of the at least a subset of the plurality of antenna slots may be elongated so as to define a longitudinal axis that is at aligned, at least substantially aligned, parallel, or at least substantially parallel to an elongated axis of its corresponding waveguide and/or waveguide ridge.

In some embodiments comprising waveguide ridge(s), at least one waveguide ridge may terminate at a terminal end, which terminal end may be positioned within a region adjacent an antenna slot, the region between defined, at least in part, by projecting (virtually) opposing sidewalls of the corresponding antenna slot (the opposing sidewalls of which, in some embodiments, may define an elongated axis of the antenna slot) towards the region (the region within which the terminal end is positioned).

In some embodiments comprising waveguide ridge(s), at least one waveguide ridge may terminate at a terminal end, which terminal end may be positioned outside of (rather than within) a region adjacent an antenna slot, the region between defined, at least in part, by projecting (virtually) opposing sidewalls of the corresponding antenna slot (the opposing sidewalls of which, in some embodiments, may define an elongated axis of the antenna slot) towards the region (the region outside of which the terminal end is positioned).

In some embodiments, the non-centered configuration may be defined, at least in part, by a non-centered location at which a waveguide ridge corresponding with each antenna slot of the at least a subset of the plurality of antenna slots extends into its corresponding antenna slot.

In other antenna modules according to various embodiments, the module may comprise a plurality of waveguides. In some embodiments, a waveguide ridge may extend along each waveguide of the plurality of waveguides. Each waveguide ridge may define a waveguide ridge axis.

The module may further comprise a plurality of antenna slots. Each waveguide ridge may extend towards and terminate adjacent to a corresponding antenna slot. In some embodiments, each antenna slot of the plurality of antenna slots may define an elongated axis that is non-perpendicular to a waveguide axis and/or waveguide ridge axis of its corresponding waveguide and/or waveguide ridge. For example, in some such embodiments, each antenna slot of the plurality of antenna slots may define an elongated axis that is aligned with and/or parallel, or at least substantially parallel, to the waveguide axis and/or waveguide ridge axis of its corresponding waveguide and/or waveguide ridge.

In some embodiments, each waveguide of the plurality of waveguides is defined by a plurality of posts. Thus, each waveguide ridge may be positioned in between at least two opposing rows of the plurality of posts within the waveguide.

In some embodiments, at least one waveguide of the plurality of waveguides may at least partially circumscribe an antenna slot such that the antenna slot is non-centered with respect to the at least one waveguide within a terminal portion of the at least one waveguide adjacent to the antenna slot.

In some embodiments, the at least one waveguide may be at least substantially aligned with a first side of the antenna slot. In some embodiments, a gap or gap region may be defined on a side of the antenna slot opposite from the first side of the antenna slot between the second side of the antenna slot and the at least one waveguide adjacent thereto. Although a “gap” of some sort may be present, in some embodiments, adjacent to both sides of the antenna slot, the term “gap,” as used herein, will typically refer to embodiments in which only a single gap is present adjacent to the antenna slot or, alternatively, embodiments in which more than one gap is present adjacent to the antenna slot, but one of these is larger than the others, and will therefore be considered the functional “gap” of the configuration.

The features, structures, steps, or characteristics disclosed herein in connection with one embodiment may be combined in any suitable manner in one or more alternative embodiments.

### BRIEF DESCRIPTION OF THE DRAWINGS

Non-limiting and non-exhaustive embodiments of the disclosure are described, including various embodiments of the disclosure with reference to the figures, in which:

FIG. 1A is a plan view of a waveguide and/or antenna module according to some embodiments;

FIG. 1B is a perspective view of the waveguide and/or antenna module of FIG. 1 with transparency to depict the structure of the antenna slot;

FIG. 2 is a plan view of a waveguide and/or antenna module according to other embodiments;

FIG. 3 is a plan view of a vehicle sensor module comprising a plurality of waveguides and corresponding antenna slots according to some embodiments;

FIG. 4 is a plan view of a waveguide and/or antenna module according to still other embodiments; and

FIG. 5 is a plan view of a waveguide and/or antenna module according to further embodiments.

### DETAILED DESCRIPTION

It will be readily understood that the components of the present disclosure, as generally described and illustrated in the drawings herein, could be arranged and designed in a wide variety of different configurations. Thus, the following more detailed description of the embodiments of the apparatus is not intended to limit the scope of the disclosure but is merely representative of possible embodiments of the disclosure. In some cases, well-known structures, materials, or operations are not shown or described in detail.

As used herein, the term “substantially” refers to the complete or nearly complete extent or degree of an action, characteristic, property, state, structure, item, or result to function as indicated. For example, an object that is “substantially” cylindrical or “substantially” perpendicular would mean that the object/feature is either cylindrical/perpendicular or nearly cylindrical/perpendicular so as to result in the same or nearly the same function. The exact allowable degree of deviation provided by this term may depend on the specific context. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it completely lacked a bottom.

Similarly, as used herein, the term “about” is used to provide flexibility to a numerical range endpoint by providing that a given value may be “a little above” or “a little below” the endpoint while still accomplishing the function associated with the range.

The embodiments of the disclosure may be best understood by reference to the drawings, wherein like parts may be designated by like numerals. It will be readily understood that the components of the disclosed embodiments, as generally described and illustrated in the figures herein, could be arranged and designed in a wide variety of different configurations. Thus, the following detailed description of the embodiments of the apparatus and methods of the disclosure is not intended to limit the scope of the disclosure, as claimed, but is merely representative of possible embodiments of the disclosure. In addition, the steps of a method do not necessarily need to be executed in any specific order, or even sequentially, nor need the steps be executed only once, unless otherwise specified. Additional details regarding certain preferred embodiments and implementations will now be described in greater detail with reference to the accompanying drawings.

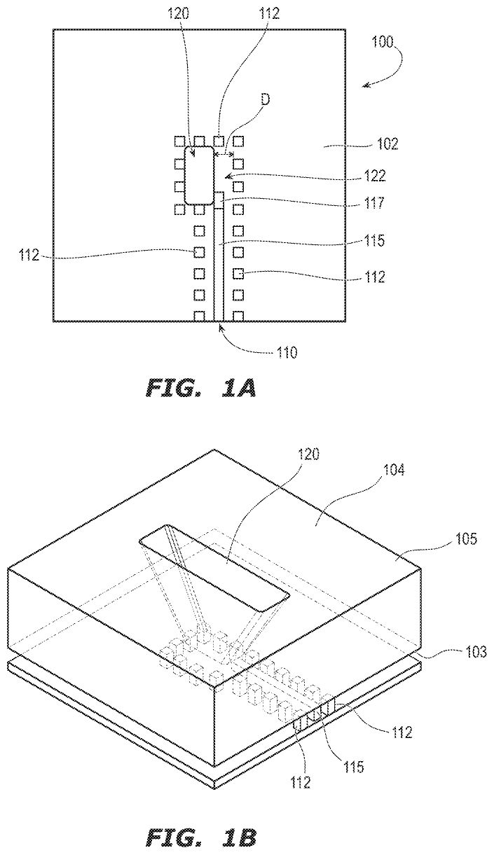

FIG. 1A depicts a first side and/or layer 102 of a portion of an antenna and/or waveguide assembly 100 that defines, either in whole or in part, one or more waveguides therein and may comprise a portion of, for example, an antenna and/or sensor module, which module may comprise one or more antennae. Waveguide/antenna/sensor assembly 100 may therefore be incorporated into or otherwise used with a vehicle sensor, such as a RADAR sensor assembly, according to some embodiments.

As depicted in FIG. 1, assembly 100 comprises a waveguide 110 defined by rows of adjacent posts 112 forming the waveguide 110 therebetween. In the depicted embodiment, two rows of posts 112 form waveguide 110 therebetween. However, as those of ordinary skill in the art will appreciate, alternative configurations for defining one or more waveguides are possible. For example, in some embodiments, multiple rows of adjacent posts 112 may be positioned on either side of the waveguide defined therebetween. In other embodiments, one or more of the waveguides may comprise a “trench-like” waveguide defined by solid, opposing sidewalls rather than adjacent posts 112 having spaces therebetween, as shown in FIG. 1A.

As also shown in FIG. 1A, a waveguide ridge 115 is positioned within waveguide 110. Similarly, although only one waveguide 110 is shown in FIG. 1A, in preferred embodiments, multiple waveguides are defined on a block, casting, layer(s), or other structure of a sensor assembly, each of which may comprise a waveguide ridge 115 extending therein.

It should be understood, however, that other embodiments are contemplated in which waveguide ridges are absent. In other words, waveguides may be defined, either by way of one or more rows of posts 112 on either side of the waveguide or, alternatively, by way of trench-style waveguides having continuous sidewalls, that may lack a waveguide ridge, such as waveguide ridge 115, extending therein.

In some embodiments in which waveguide ridges 115 are present, each of, or at least a subset of, the waveguide ridges 115 may extend at a central, or at least substantially central, position within its respective waveguide 110. For example, in some embodiments, the waveguide ridge(s) 115 may be positioned halfway, or about halfway, between the opposing posts 112 (or sidewalls in other embodiments). In addition, or alternatively, the waveguide ridge(s) 115 may extend along, or at least substantially along, the axis of its corresponding waveguide(s) 110.

Electromagnetic radiation may travel within the waveguides defined by the aforementioned posts 112 and/or ridges 115 and may be transmitted through a corresponding antenna slot 120. Ridges 115 may be preferred to enhance the characteristics of the waveguide by further facilitating guidance of electromagnetic waves as desired and/or for satisfying size/dimensional demands.

In some embodiments, the portion of waveguide ridge 115 that is positioned at the terminal end 117 of the ridge 115 adjacent to the corresponding antenna slot 120 of the ridge 115 may be shorter in height. In the depicted embodiment, this terminal end comprises a stepped region that steps down in height from the adjacent portion of the waveguide ridge 115, but this transition may be gradual, or absent altogether, in alternative embodiments.

As further depicted in FIG. 1A, the antenna slot 120 is elongated. In other words, it comprises an elongated axis that extends a greater distance than an axis normal to the elongated axis. In this embodiment, the elongated axis of antenna slot 120 is parallel to the axis (also elongated) of waveguide ridge 115. However, the axis of waveguide ridge 115 is adjacent to, but outside of, the “footprint” or width of its corresponding antenna slot 120. In other words, waveguide ridge 115 terminates at a terminal end 117 that is positioned outside of a region adjacent to antenna slot 120 that is defined, at least in part, by virtually projecting opposing sidewalls of antenna slot 120 towards the region (these opposing sidewalls defining, at least in part, an elongated axis of the antenna slot 120). The waveguide ridge 115 therefore terminates immediately adjacent to the antenna slot 120 on the right side (rather than into, since the axis of the ridge 115 does not lead directly into) of the antenna slot 120. In embodiments in which a waveguide ridge 115 is present, it can be thought of as a transmission line that facilitates transfer of electromagnetic fields/energy along its axis/length. The terminal end 117 may be used to facilitate coupling of such fields/energy to the adjacent antenna slot 120, and therefore terminal end 117 may be stepped down or otherwise decreased in height relative to the adjacent portion, and in some cases the entire remaining length of, the waveguide ridge 115.

It can also be seen in FIG. 1A that antenna slot 120 is non-centered with respect to opposing sides of the waveguide 110 in the terminal end region of the waveguide 110 adjacent to antenna slot 120. In this embodiment, it can be seen that this non-centered or off-centered configuration is provided, at least in part, by the presence of a gap 122 between a side of the antenna slot 120 and an adjacent side of the waveguide 110, which, again, is defined by posts 112 in this case.

In addition, in the depicted embodiment, waveguide 110 at least partially circumscribes the antenna slot 120 such that the antenna slot 120 is non-centered within a terminal end of the waveguide.

Gap 122 may be configured to improve the ability of the waveguide 110 and/or waveguide ridge 115 to couple electromagnetic signals/energy to the antenna slot 120. In some embodiments, this gap 122 may be configured to function as a phase-shifting feature to confine the accompanying electromagnetic field(s) and/or to obtain a desired impedance matching with respect to the waveguide 110.

In preferred embodiments, gap 122 may function as a quarter-wavelength stub. In other words, gap 122 may comprise a distance “D” that is about one-fourth of the wavelength of RADAR with which the vehicle sensor/module is configured to operate. Thus, for example, in the case of 77 GHz RADAR, this distance may be about 0.98 mm, which is ¼ of the wavelength of the RADAR (3.9 mm).

In the depicted embodiment, this distance “D” is the distance from one edge/side of the antenna slot 120 (the side closest to the gap 122) and the adjacent sidewall of the waveguide 110. In some embodiments, however, this distance may not be the same along the entire gap 122. Thus, the distance D may be, in some embodiments, a maximum distance or, alternatively, an average distance between the aforementioned edge/side of the antenna slot 120 and the adjacent waveguide 110, which may be defined by one or more adjacent posts or continuous sidewalls.

In some alternative configurations, terminal end 117 of waveguide ridge 115 may extend further towards the end of gap 122. Indeed, in some cases, the terminal end 117 may even contact, at least substantially contact, and/or merge with one or more of the posts 112 defining gap 122. This may allow for using the height of the terminal end 117, the length of the terminal end 117, and/or the location of termination of the waveguide ridge 115 and/or terminal end 117 as design parameters to improve performance.

Although use of a quarter-wavelength gap 122 may be preferred, it should be understood that there may be flexibility in terms of the size and/or shape of this gap 122 without destroying or unduly hindering its functionality. Thus, in some embodiments, distance D of gap 122 may be about ¼ of the wavelength of the associated electromagnetic radiation +/−30%. Thus, for example, for a 77 GHz RADAR sensor module/assembly, the distance D of gap 122 may be between about 0.6 mm and about 1.3 mm.

In the embodiment of FIG. 1A, the side of antenna slot 120 opposite from gap 122 contains no gap or space whatsoever. In other words, each of the posts 112 on this side is aligned, or at least substantially aligned, with the adjacent side of antenna slot 120. However, this need not be the case for all contemplated embodiments. Rather, in some embodiments, some space may be provided on this side as well. However, in preferred embodiments, the antenna slot 120 is offset or non-centered with respect to these opposing sides of waveguide 110 such that gap 122 is larger than whatever corresponding space, if any, is present on any other sides, such as the opposite side, of antenna slot 120.

It can also be seen in FIG. 1A that waveguide ridge 115 or, more specifically in this case, the stepped-down terminal end 117 of waveguide ridge 115, extends directly into gap 122. Again, however, this need not always be the case, as will be apparent after considering other embodiments discussed below.

It should also be understood that although, in the example of FIGS. 1A and 1B, only a single waveguide 110, waveguide ridge 115, and antenna slot 120 are shown, any number of waveguides, waveguide ridges, and/or antennae slots may be provided in a more complete assembly/module. In addition, such waveguides, waveguide ridges, and/or antennae slots may curve about the assembly rather than be in a series of parallel lines in some embodiments. As another example, in some embodiments, grooves, ridges, slots, or the like may be arranged in a disc formation, or any other suitable formation, including linear, curved, etc.

In preferred embodiments, the structure defining the various waveguides 110, waveguide ridges 115, and in some cases, the antenna slots 120 as well, may comprise a casting, such as a casting comprising a Zinc or other suitable preferably metal material. However, in other contemplated embodiments, the structure may instead, or in addition, comprise a plastic or other material. In some such embodiments, metallic inserts, coatings, or the like may be used if desired. In typical sensor assemblies, which, as previously mentioned, may be configured specifically for use in connection with vehicles, other structures, such as additional layers, which may define the antenna slots in some embodiments, may be combined with the block/casting structure defining the waveguides.

FIG. 1B depicts a second layer 104 of antenna and/or waveguide assembly 100. As shown in this figure, the antenna slot 120, which extends from a first side 103 to a second side 105 of layer 104, comprises a horn structure. In other words, the cross-sectional area of antenna slot 120 increases in size gradually, due to outwardly sloping sidewalls extending between sides 103 and 105. This is, of course, just an option.

For example, the antenna slots 120 need not be sloped and/or horned. Moreover, various other options are contemplated. For example, although in the depicted embodiment separate layers 102 and 104 are used to define the waveguide 110 and the adjacent antenna slot 120, in some alternative embodiments, electromagnetic radiation may be emitted using antenna slots or openings formed in the same layer/block/casting/structure that defines the waveguide 110.

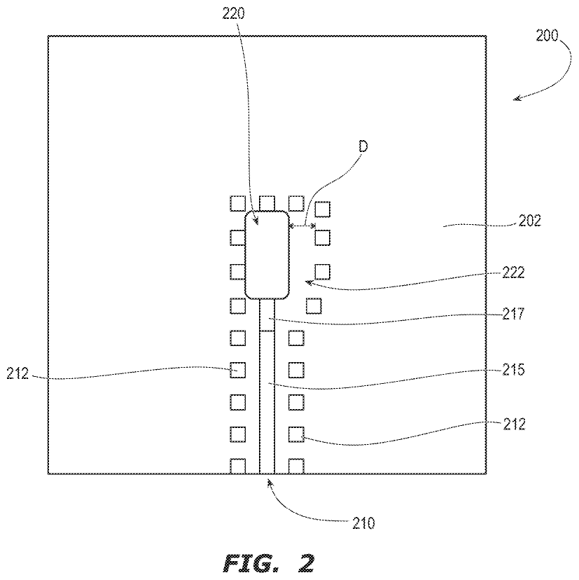

FIG. 2 depicts an alternative embodiment of a waveguide and/or antenna module or assembly 200, or portion thereof. As depicted in FIG. 2, assembly 200 comprises a waveguide 210 defined by rows of adjacent posts 212 forming the waveguide 210 therebetween. In the depicted embodiment, two rows of posts 212 form waveguide 210 therebetween. However, again, alternative configurations for defining one or more waveguides are possible, such as embodiments comprising more than a single row of adjacent posts 212 positioned on either side of the waveguide 210 defined therebetween. As mentioned above, other types of waveguide structures, such as waveguides defined by continuous walls, may also be used.

As also shown in FIG. 2, a waveguide ridge 215 is, once again, positioned within waveguide 210. Waveguide ridge 215 extends at a central position within, and along the axis of, its respective waveguide 210.

Waveguide ridge 215 terminates adjacent to (and into, in this case) an antenna slot 220, which may include some or all of the features of antenna slot 120, or any other antenna slots described herein. For example, antenna slot 220 may, but need not, be formed in a separate layer of assembly 200. Similarly, antenna slot 220 may, but need not, comprise a tapered and/or horn-like structure.

Like antenna slot 120, antenna slot 220 is elongated and comprises an elongated axis that extends a greater distance than an axis normal to the elongated axis. The elongated axis of antenna slot 220 is also parallel to the elongated axis of waveguide ridge 215. However, unlike antenna slot 120, the axis of waveguide ridge 215 extends directly towards and into antenna slot 220. In other words, waveguide ridge 215 terminates at a terminal end 217 that is positioned in a region adjacent to antenna slot 220 that is defined, at least in part, by virtually projecting opposing sidewalls (these sidewalls defining an elongated axis of the slot 220) of antenna slot 220 in a direction towards the region. The waveguide ridge 215 therefore terminates immediately adjacent to the antenna slot 220 in front of, and into, the antenna slot 220.

It can also be seen in FIG. 2 that antenna slot 220 is non-centered with respect to opposing sides of the adjacent portion of its waveguide 210. This off-centered configuration is provided, at least in part, by the presence of a gap 222 between a side of the antenna slot 220 and an adjacent side of the waveguide 210, which, again, is defined by posts 212.

Gap 222, like gap 122, may be configured to improve the ability of the waveguide 210 and/or waveguide ridge 215 to couple electromagnetic signals/energy to the antenna slot 220. In some embodiments, this gap 222 may be configured to function as a phase-shifting feature to confine the accompanying electromagnetic field(s) and/or to obtain a desired impedance matching with respect to the waveguide 210.

Gap 222 may function as a quarter-wavelength stub and may therefore, in preferred embodiments, comprise a distance “D” that is about one-fourth of the wavelength of RADAR with which the vehicle sensor/module is configured to operate. Again, in the case of 77 GHz RADAR, this distance may be about 0.98 mm, which is ¼ of the wavelength of the RADAR (3.9 mm). This distance D, however, may vary, such as, in some embodiments, by about +/−30%.

In the depicted embodiment, this distance “D” is the distance from one edge/side of the antenna slot 220 and the adjacent sidewall of the waveguide 210. As previously mentioned, this distance may not be the same along the entire gap 222 and may therefore comprise a maximum distance or, alternatively, an average distance between the aforementioned edge/side of the antenna slot 220 and the adjacent waveguide 210.

Waveguide ridge 215 may comprise a terminal end 217 adjacent to antenna slot 220, which, in some embodiments, may be stepped or otherwise shorter in height than the adjacent portion (in the direction away from antenna slot 220) of waveguide ridge 215.

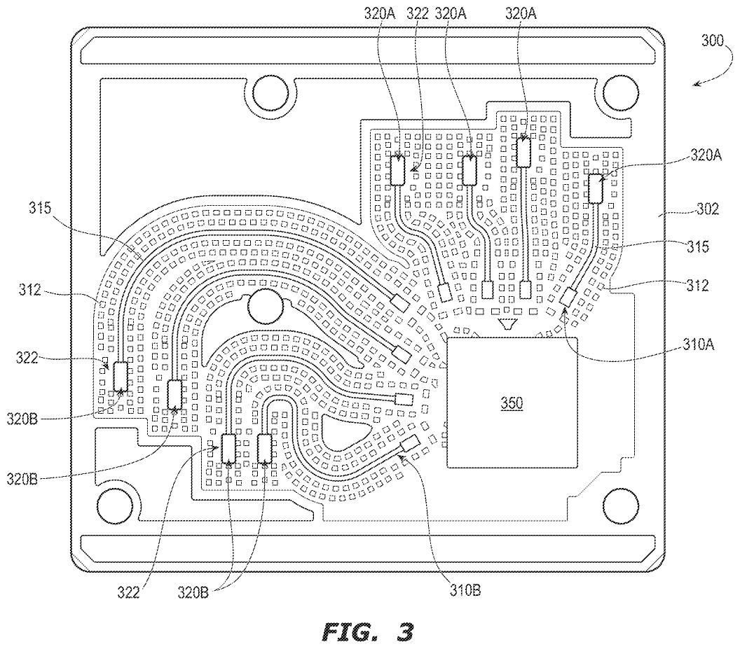

FIG. 3 depicts an example of a more complete assembly/module 300, which may be used in, for example, a RADAR and/or sensor assembly for a vehicle.

Assembly 300 comprises an array of waveguides, waveguide ridges, and corresponding antennae slots. In this embodiment, these structures are divided into functional sub-arrays, namely, an RX section and a TX section, both of which comprise four, respective waveguides, waveguide ridges, and antenna slots.

More particularly, the RX section of assembly 300 comprises four waveguides 310A, each of which has a corresponding waveguide ridge 315 extending therein, each of which terminates in a corresponding antenna slot 320A. Each of the various waveguides 310A is defined by rows of posts 312 on either side of each waveguide 310A. In this embodiment, each of the waveguides 310A (and, as discussed below, waveguides 310B of the TX section of assembly 300) is defined by multiple rows of such posts 312 on each opposing side of each waveguide 310A.

Similarly, the TX section of assembly 300 comprises four waveguides 310B, each of which has a corresponding waveguide ridge 315 extending therein, each of which terminates in a corresponding antenna slot 320B. Each of the various waveguides 310A/310B may be configured to transmit, receive, and/or alter electromagnetic signals. Any of the various slots, grooves, waveguides, or other structures and/or features described herein may be formed directly into a single body 302, such as by way of a die cast mold or the like, or may be formed into one or more layers or other structures coupled to body 302. Alternatively, body 302 may be formed from an injection molding process and/or may comprise metallized plastic or the like.

It should be understood, however, that antenna slots 320A/320A or another antenna structure may be, in some embodiments, formed in another portion of the assembly/module 300 and/or formed in an alternative manner. For example, in some embodiments, antenna slots 320A/320A may be formed within a lid/plate or other separate layer, which may be coupled to one or more adjacent waveguides rather than incorporating the waveguides into the same, unitary structure defining the antenna slots 320A/320A.

Each of the various antenna slots 320A and 320B is elongated and comprises an elongated axis that extends at least substantially parallel with its corresponding waveguide 310A/310B and its corresponding waveguide ridge 315 (at least in the region of the waveguide immediately adjacent to the antenna slot 320A/320B).

In addition, each of the various antenna slots 320A/320B is non-centered with respect to opposing sides of its associated waveguide 310A/310B. This non-centered configuration is defined, at least in part, by the presence of a gap 322 that is present on one side of each antenna slot 320A, and each antenna slot 320B, between a first side of each antenna slot 320A/320B and a first side of the respective waveguide 310A/310B adjacent to the first side of each antenna slot 320A/320B.

As mentioned above, each of these gaps 322 preferably comprises a distance, which may comprise an average distance in some cases, of about one-fourth of a wavelength of RADAR for which the vehicle sensor is configured to operate. Thus, in some embodiments configured for use in connection with RADAR sensors for vehicles, each gap 322 may comprise a distance and/or an average distance of between about 0.6 mm and about 1.3 mm.

It can also be seen in FIG. 3 that, although the majority of each of the various waveguides 310A/310B is defined by multiple rows of posts 312 on each side of each respective waveguide 310A/310B, the gaps 322 may be defined by using only one row of posts 312 to “fence in” the waveguide within the region of the gaps 322.

Assembly/module 300 further comprises a hub region 350 from which each of the aforementioned waveguides 310A/310B initiates and/or terminates to allow for sending and receiving of electromagnetic signals. It should be understood that hub region 350 would typically include various electrical components, such as electromagnetic generation chips or other elements, that are not shown in the figures to avoid obscuring the disclosure. A suitable electromagnetic feed or transition structure may also be used to facilitate transitioning electromagnetic waves/signals to and/or from the waveguides 310A/310B as needed.

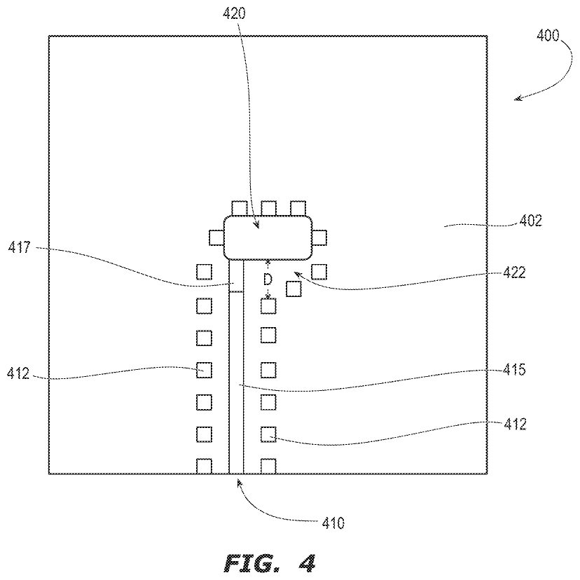

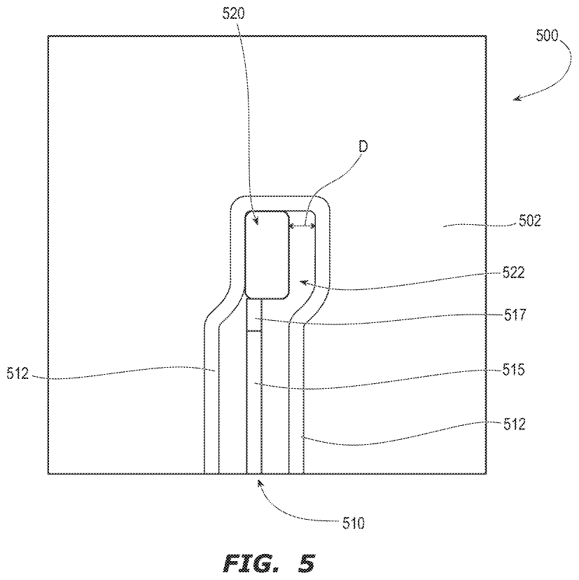

Two additional examples of assemblies/modules are shown in FIGS. 4 and 5. After considering assembly/module 300 of FIG. 3, however, it should be understood that it is more likely that these figures depict smaller, respective portions of a larger assembly comprising multiple waveguides, waveguide ridges, and/or corresponding antenna slots, along with various other electronic components as needed.

Assembly 400 of FIG. 4 comprises a waveguide 410 defined by rows of adjacent posts 412 forming the waveguide 410 therebetween. In addition, a waveguide ridge 415 is positioned within waveguide 410.

Waveguide ridge 415 extends at a central position within, and along the axis of, its respective waveguide 410, and terminates adjacent to (and into, in this case) an antenna slot 420. Antenna slot 420 is elongated and comprises an elongated axis that extends a greater distance than an axis normal to the elongated axis. However, unlike previous embodiments, the elongated axis of antenna slot 420 is perpendicular to the elongated axis of waveguide ridge 415. The axis of waveguide ridge 415 extends directly towards and into antenna slot 420 at one end of the elongated antenna slot 420.

Still, the antenna slot 420 is positioned in a non-centered configuration with respect to the adjacent waveguide 410 due, at least in part, to a non-centered location at which waveguide ridge 415 extends into antenna slot 420.

In addition, a gap 422 is present on one side of waveguide 410 and waveguide ridge 415. Gap 422 is also positioned adjacent to one elongated side of antenna slot 420. However, because antenna slot 420 extends perpendicular to waveguide 410 and waveguide ridge 415, the distance D that defines gap 422 extends in a direction that is parallel to that of the adjacent waveguide 410 and waveguide ridge 415 rather than transverse and/or perpendicular thereto, as with other embodiments.

Gap 422 may be configured to improve the ability of the waveguide 410 and/or waveguide ridge 415 to couple electromagnetic signals/energy to the antenna slot 420. In some embodiments, this gap 422 may be configured to function as a phase-shifting feature to confine the accompanying electromagnetic field(s) and/or to obtain a desired impedance matching with respect to the waveguide 410.

Gap 422 may further function as a quarter-wavelength stub and may therefore, in preferred embodiments, comprise a distance “D” that is about one-fourth of the wavelength of RADAR with which the vehicle sensor/module is configured to operate. Again, in the case of 77 GHz RADAR, this distance may be about 0.98 mm, which is ¼ of the wavelength of the RADAR (3.9 mm). This distance D, however, may vary, such as, in some embodiments, by about +/−30%.

In the depicted embodiment, this distance “D” is the distance from one edge/side of the antenna slot 420 and the adjacent sidewall of the waveguide 410. However, as previously mentioned, this distance may not be the same along the entire gap 422 and may therefore comprise a maximum distance or, alternatively, an average distance between the aforementioned edge/side of the antenna slot 420 and the adjacent waveguide 410 in a direction corresponding to the distance D, which is typically the larger distance between the posts/walls defining the waveguide 410 and the antenna slot 420.

Moreover, as mentioned in connection with other embodiments, various parameters may be used as design parameters to tune performance, such as the length and/or height of the terminal end 417, which may be stepped down in height relative to the rest of waveguide ridge 415, along with the distance D, the distance of the gap 422 in the direction normal to D, and/or the positioning of the posts 412 or other structure defining the bounds of gap 422.

As previously mentioned, the side opposite the gap may have no, or at least substantially no, space between the antenna slot and waveguide walls/posts, as is the case with assembly 400. However, in other embodiments, there may be some space opposite the gap (preferably less space than the gap).

Waveguide ridge 415 may further comprise a terminal end 417 adjacent to antenna slot 420, which, in some embodiments, may be stepped or otherwise shorter in height than the adjacent portion (in the direction away from antenna slot 420) of waveguide ridge 415.

As previously mentioned, antenna slot 420 may, but need not, be formed in a separate layer of the assembly 400. Similarly, antenna slot 420 may, but need not, comprise a tapered and/or horn-like structure.

Assembly 500 of FIG. 5 comprises a waveguide 510. However, unlike the waveguides defined by spaced, adjacent posts, waveguide 510 is defined by continuous sidewalls 512 defining a trench-style waveguide 510. This trench waveguide 510 extends about and at least partially circumscribes antenna slot 520.

In addition, a waveguide ridge 515 is positioned within and extends along the axis of waveguide 510. Again, waveguide ridge 515 preferably extends along a central, or at least substantially central, portion of the waveguide 510, along at least a portion (in some cases, at least a majority of) the waveguide 510.

Waveguide ridge 515 terminates adjacent to, and into, antenna slot 520. Antenna slot 520 is elongated and comprises an elongated axis that extends a greater distance than an axis normal to the elongated axis. The elongated axis of waveguide ridge 515 is parallel to the elongated axis of antenna slot 520 and extends directly into antenna slot 520.

Waveguide ridge 515, however, extends into antenna slot 520 in a non-centered location. In this case, waveguide ridge 515 extends into antenna slot 520 along, or at least substantially along, one side of antenna slot 520.

As with the previous embodiments, antenna slot 520 may, but need not, be formed in a separate layer of the assembly 500. Similarly, antenna slot 520 may, but need not, comprise a tapered and/or horn-like structure.

It can also be seen in FIG. 5 that antenna slot 520 is non-centered with respect to opposing sides of the adjacent portion of its waveguide 510. This off-centered configuration is provided, at least in part, by the presence of a gap 522 between a side of the antenna slot 520 and an adjacent side of waveguide 510, which, again, is defined by continuous sidewall 512.

Gap 522 may be configured to improve the ability of the waveguide 510 and/or waveguide ridge 515 to couple electromagnetic signals/energy to the antenna slot 520. In some embodiments, this gap 522 may be configured to function as a phase-shifting feature to confine the accompanying electromagnetic field(s) and/or to obtain a desired impedance matching with respect to the waveguide 510.

Gap 522 may function as a quarter-wavelength stub and may therefore, in preferred embodiments, comprise a distance “D” that is about one-fourth of the wavelength of RADAR with which the vehicle sensor/module is configured to operate. Again, in the case of 77 GHz RADAR, this distance may be about 0.98 mm, which is ¼ of the wavelength of the RADAR (3.9 mm). Again, distance D may vary by about +/−30% in various contemplated preferred embodiments.

In the depicted embodiment, this distance “D” is the distance from one edge/side of the antenna slot 520 and the adjacent sidewall 512 of the waveguide 510. As previously mentioned, this distance may not be the same along the entire gap 522 and may therefore comprise a maximum distance or, alternatively, an average distance between the aforementioned edge/side of the antenna slot 520 and the adjacent waveguide 510. This can be seen in FIG. 5, which illustrates a portion of waveguide sidewall 512 near the proximal/bottom portion of antenna slot 520 being slightly closer to antenna slot 510 than distance D.

Waveguide ridge 515 may comprise a terminal end 517 adjacent to antenna slot 520, which, in some embodiments, may be stepped or otherwise shorter in height than the adjacent portion of waveguide ridge 515. As previously mentioned, however, this feature is optional, as are all features not specifically claimed or indicated as essential herein.

As those of ordinary skill in the art will appreciate, antenna/waveguide/sensor assemblies incorporating the waveguide/antenna structures described herein may further comprise a PCB or other electromagnetic-generating element from which electromagnetic waves may be generated to feed one or more waveguide structures. These elements may be provided in a separate layer or, alternatively, may be provided in the same layer.

It should also be understood that whereas preferred embodiments may be used in connection with vehicle sensors, such as vehicle RADAR modules or the like, the principles disclosed herein may be used in a wide variety of other contexts, such as other types of RADAR assemblies, including such assemblies used in aviation, maritime, scientific applications, military, and electronic warfare. Other examples include point-to-point wireless links, satellite communication antennas, other wireless technologies, such as 5G wireless, and high-frequency test- and scientific instrumentation. Thus, the principles disclosed herein may be applied to any desired communication sub-system and/or high-performance sensing and/or imaging systems, including medical imaging, security imaging and stand-off detection, automotive and airborne radar and enhanced passive radiometers for earth observation and climate monitoring from space.

The foregoing specification has been described with reference to various embodiments and implementations. However, those of ordinary skill in the art will appreciate that various modifications and changes can be made without departing from the scope of the present disclosure. For example, various operational steps, as well as components for carrying out operational steps, may be implemented in various ways depending upon the particular application or in consideration of any number of cost functions associated with the operation of the system. Accordingly, any one or more of the steps may be deleted, modified, or combined with other steps. Further, this disclosure is to be regarded in an illustrative rather than a restrictive sense, and all such modifications are intended to be included within the scope thereof. Likewise, benefits, other advantages, and solutions to problems have been described above with regard to various embodiments. However, benefits, advantages, solutions to problems, and any element(s) that may cause any benefit, advantage, or solution to occur or become more pronounced, are not to be construed as a critical, a required, or an essential feature or element.

Those having skill in the art will appreciate that many changes may be made to the details of the above-described embodiments without departing from the underlying principles of the invention. The scope of the present inventions should, therefore, be determined only by the following claims.

1. An antenna module for a vehicle sensor, comprising:
a waveguide;
a waveguide ridge extending within the waveguide, wherein the waveguide ridge comprises an elongated axis along which the waveguide ridge extends; and
an antenna slot operably coupled with the waveguide, the antenna slot comprising an elongated axis along which the antenna slot extends, wherein the elongated axis of the antenna slot is at least substantially aligned with or at least substantially parallel to the elongated axis of the waveguide ridge.

2. The antenna module of claim 1, wherein the waveguide extends along a side of the antenna slot.

3. The antenna module of claim 2, wherein the waveguide extends along both opposing sides of the antenna slot defining the elongated axis of the antenna slot.

4. The antenna module of claim 3, wherein the antenna slot is non-centered with respect to opposing sides of the waveguide adjacent to the opposing sides of the antenna slot.

5. The antenna module of claim 4, further comprising a gap between a first side of the antenna slot and a first side of the waveguide adjacent to the first side of the antenna slot.

6. The antenna module of claim 5, wherein the gap comprises an average distance of between about 0.6 mm and about 1.3 mm.

7. The antenna module of claim 5, wherein the gap comprises an average distance of about one-fourth of a wavelength of RADAR for which the vehicle sensor is configured to operate.

8. The antenna module of claim 1, wherein the waveguide is defined in between two or more rows of opposing posts.

9. An antenna module, comprising:
a plurality of waveguides;
a plurality of waveguide ridges, each waveguide ridge of the plurality of waveguide ridges being positioned and extending within a corresponding waveguide of the plurality of waveguides; and
a plurality of antenna slots, each antenna slot of the plurality of antenna slots being positioned within a terminal end of a corresponding waveguide of the plurality of waveguides,
wherein each antenna slot of at least a subset of the plurality of antenna slots is positioned in a non-centered configuration within the terminal end of its corresponding waveguide.

10. The antenna module of claim 9, wherein the non-centered configuration is defined, at least in part, by a gap between a first side of each antenna slot of the at least a subset of the plurality of antenna slots and an adjacent side of its corresponding waveguide.

11. The antenna module of claim 10, wherein the gap comprises an average distance of between about 0.6 and about 1.3 mm.

12. The antenna module of claim 9, wherein each antenna slot of the at least a subset of the plurality of antenna slots is elongated so as to define a longitudinal axis that is at least substantially aligned or at least substantially parallel to an elongated axis of its corresponding waveguide ridge.

13. The antenna module of claim 12, wherein at least one waveguide ridge terminates at a terminal end, the terminal end being positioned in a region adjacent an antenna slot, the region between defined, at least in part, by projecting opposing sidewalls of its corresponding antenna slot towards the region, the opposing sidewalls defining an elongated axis of the corresponding antenna slot.

14. The antenna module of claim 12, wherein at least one waveguide ridge terminates adjacent at a terminal end, the terminal end being positioned outside of a region adjacent an antenna slot, the region between defined, at least in part, by projecting opposing sidewalls of its corresponding antenna slot towards the region, the opposing sidewalls defining an elongated axis of the corresponding antenna slot.

15. The antenna module of claim 9, wherein the non-centered configuration is defined, at least in part, by a non-centered location at which a waveguide ridge corresponding with each antenna slot of the at least a subset of the plurality of antenna slots extends into its corresponding antenna slot.

16. An antenna module, comprising:
a plurality of waveguides; and
a plurality of antenna slots, each waveguide ridge extending towards and terminating adjacent to a corresponding antenna slot, wherein each antenna slot of the plurality of antenna slots defines an elongated axis that is non-perpendicular to the waveguide ridge axis of its corresponding waveguide ridge.

17. The antenna module of claim 16, wherein each waveguide of the plurality of waveguides is defined by a plurality of posts.

18. The antenna module of claim 17, further comprising a waveguide ridge extending along each waveguide of the plurality of waveguides, each waveguide ridge defining a waveguide ridge axis, wherein each waveguide ridge is positioned in between at least two opposing rows of the plurality of posts, and wherein each antenna slot of the plurality of antenna slots defines an elongated axis that is either at least substantially aligned with or at least substantially parallel to the waveguide ridge axis of its corresponding waveguide ridge.

19. The antenna module of claim 16, wherein at least one waveguide of the plurality of waveguides at least partially circumscribes an antenna slot such that the antenna slot is non-centered with respect to the at least one waveguide.

20. The antenna module of claim 19, wherein the at least one waveguide is at least substantially aligned with a first side of the antenna slot, and wherein a gap is defined on a second side of the antenna slot opposite from the first side between the antenna slot and the at least one waveguide.
